(19) United States
(12) Patent Application Publication
(10) Pub. No.: US 2018/0192617 A1
(43) Pub. Date: Jul. 12, 2018

(54) MAGNETIC LEASH AND MAGNETIC ACCESSORIES

(71) Applicant: LaLo 4073, LLC, New York, NY (US)

(72) Inventors: Jaclyn Louise Jirsa, New York, NY (US); Tyler Harrell, Pittsburg, KS (US)

(21) Appl. No.: 15/405,274

(22) Filed: Jan. 12, 2017

(51) Int. Cl. A01K 27/00; A01K 15/02; A01K 13/00; A01K 5/00; A01K 7/00; H01F 7/02; H01F 1/03

(52) U.S. Cl. CPC A01K 27/008; A01K 27/003; A01K 27/006; A01K 15/025; H01F 1/0306; A01K 5/00; A01K 7/00; H01F 7/021; A01K 13/00

(57) ABSTRACT

Pet products may include a leash of material, a handle on one end and a releasable clasp opposite the handle for attachment to a collar or a harness of a pet. A leash magnet is affixed to the material and located between the handle and the releasable clasp. An accessory, such as a pet toy, has an accessory magnet. The accessory may be magnetically and repeatably coupled to and detached from the leash magnet on the leash.

This application claims priority to and the benefit of U.S. Prov. Pat. App. No. 62/280,462, filed Jan. 19, 2016, and is incorporated herein by reference in its entirety.

### BACKGROUND OF THE INVENTION

### Field of the Disclosure

The present invention generally relates to pet leashes and, in particular, to an improved system, method and apparatus for a magnetic leash and magnetic accessories.

### SUMMARY

Embodiments of a system, method and apparatus for a magnetic leash and magnetic accessories are disclosed. For example, a version of pet products may include a leash comprising a material, a handle on one end configured for manual engagement by a user, and a releasable clasp opposite the handle and configured to be attached to a collar or a harness of a pet. In addition, a leash magnet may be affixed to the leash and located between the handle and the releasable clasp. The pet products may include one or more accessories having an accessory magnet. The accessory may be configured to be magnetically and repeatably coupled to and detached from the leash magnet on the leash. In addition, the accessory may have a weight of at least about 3 ounces and not greater than about 8 ounces.

Embodiments of a method of walking a pet also are disclosed. In an example, the method may include providing a leash with a leash magnet and an accessory with an accessory magnet, and attaching the leash to a pet; magnetically bonding the accessory to the leash with the leash magnet and the accessory magnet; walking the pet on the leash, and permitting the pet to place the accessory in its mouth, but not the leash, while the accessory remains magnetically bonded to the leash; and permitting the pet to release the accessory from its mouth, such that the accessory remains magnetically bonded to the leash, and a person walking the pet does not have to pick up the accessory and carry the accessory.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is an exploded, isometric view of an embodiment of magnetic pet products.

FIG. 2 is an isometric view of an embodiment of a nubble ball.

FIG. 3 is an isometric view of an embodiment of a pet toy that is bone-shaped.

FIG. 4 is a side view of the pet toy of FIG. 3.

The use of the same reference symbols in different drawings indicates similar or identical items.

### DETAILED DESCRIPTION

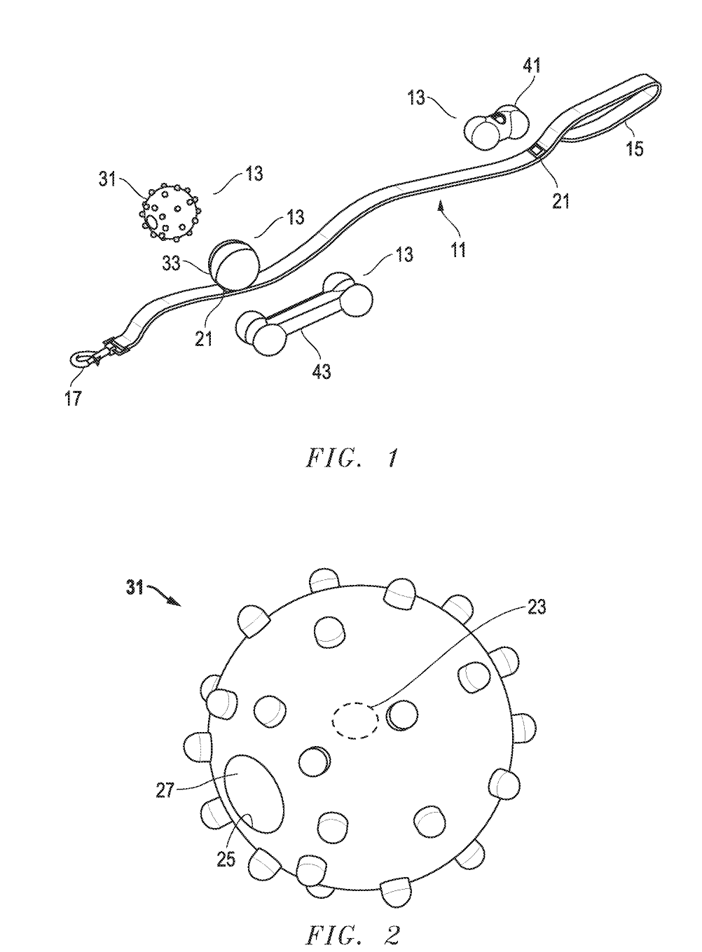

Embodiments of a system, method and apparatus for pet-related products are disclosed. For example, FIG. 1 illustrates a leash 11 that is magnetic, and accessories 13 that also are magnetic and configured for attachment to the leash 11. In one embodiment, the only way to couple the accessory 13 to the leash 11 is via magnetism. Versions of the leash 11 may include a material, such as a fabric material. The material may comprise one or more materials, such as woven polymer material, flat nylon, tubular nylon, flat leather, braided leather, cotton, chain, rope, polypropylene webbing or polyester webbing.

A handle 15 may be located on one end of the leash 11. The handle 15 may be configured for manual engagement by a user. A releasable clasp 17 may be located opposite the handle 15 and configured to be attached to a collar or a harness of a pet.

In some embodiments, at least one leash magnet 21 may be affixed to the leash 11. For example, the leash magnet 21 may be affixed to the material of the leash 11. The leash magnet 21 may be located between the handle 15 and the releasable clasp 17.

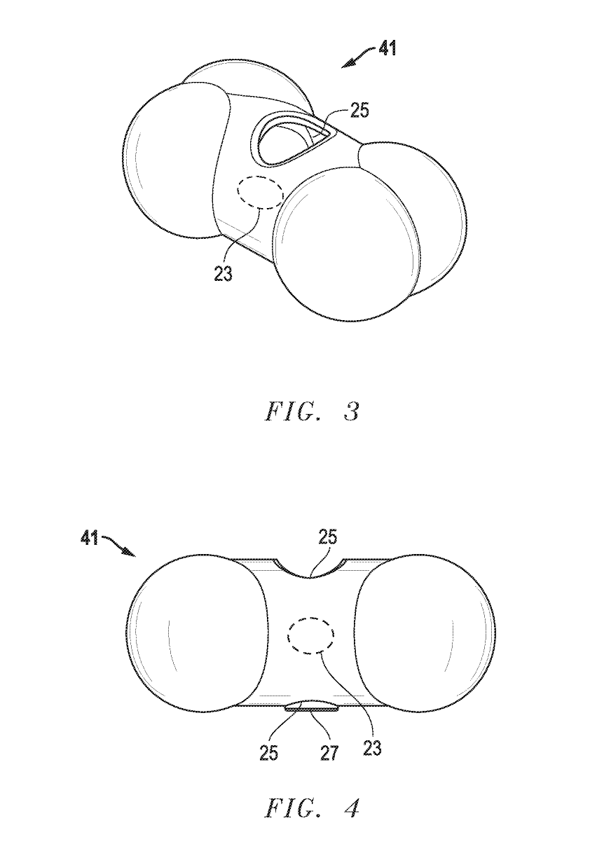

Examples of the types of items that the accessory 13 may comprise include one or more pet toys. Such pet toys may comprise a ball 33 (FIG. 1), nubble ball 31 (FIGS. 1 and 2), bone-shaped object such as pet toys 41, 43 that are bone-shaped toy (FIGS. 1, 3 and 4), pouch, waste bag dispenser, water holder, food container, grooming device, hook attachment for storage, a light or a holder configured to hold or retain a separate device. For example, the separate device can be one or more of a telephone, smartphone, key, disposable bags, liquid container, food container, grooming device, grooming wipes, wallet, identification or pet tags.

Embodiments of each accessory 13 may include at least one accessory magnet 23 (FIGS. 2-4). The accessory 13 may be configured to be magnetically and repeatably coupled to and detached from the leash magnet 21 on the leash 11. In some versions, the accessory 11 may have a weight in a selected range. For example, the weight of the accessory can be at least about 0.5 ounces. In other examples, the weight of accessory 13 can be at least about 1 ounce, such as at least about 2 ounces, or even at least about 3 ounces. In other versions, the weight of accessory 13 can be not greater than about 8 ounces. In other embodiments, the weight of the accessory 13 can be in a range between any of these values.

The leash magnet 21 may be provided with sufficient magnetic strength to magnetically retain a plurality of accessories 13 on the leash 11. For example, FIG. 1 depicts four accessories 13, including the nubble ball 31, a ball 33, and two bone-shaped pet toys 41, 43. One or more of the accessories 13 may be configured to be magnetically retained by the one or more leash magnets 21 on a first side of the leash 11. Other ones of the accessories 13 may be configured to be magnetically retained by the leash magnet(s) 21 on a second side of the leash 11.

In some examples, both the leash magnet 21 and the accessory magnet 23 may comprise neodymium magnets or ceramic magnets. Optionally, the leash magnet 21 and the accessory magnet 23 may be nickel plated.

Versions of the leash magnet 21 may be embedded in the leash 11. In some embodiments, the leash magnet 21 may be sewn in a pouch on the leash 11. Such a pouch may include a pouch cover sewn to the leash 11. The pouch cover can have a thickness that is less than that of the leash 11.

Other embodiments of the leash magnet 21 may include only two leash magnets 21 that are spaced apart from each other on the leash 11. The leash magnet 21 may include a first leash magnet 21 located adjacent the handle 15, and a second leash magnet 21 located adjacent to the releasable clasp 17. In one example, the first leash magnet 21 may be located closer to the handle 15 than the second leash magnet 21 is located relative to the releasable clasp 17.

Embodiments of the leash magnet 21 may include a first polarity oriented toward the leash 11. A second polarity of the leash magnet 21 may be oriented away from the leash 11, such that all of the leash magnets 21 can share a same orientation with respect to the leash 11. The leash magnets 21 may be spaced apart from each other along the leash 11, as illustrated in FIG. 1. In the examples of leash 11 having at least two leash magnets 21, the leash magnets 21 may be located on opposite sides of the leash 11.

In one version, each of the leash magnets 21 may weigh at least about 0.25 ounces. Embodiments of the leash magnet 21 may include a surface field or surface gauss. The surface field can be at least about 1500 Gauss, such as at least about 2000 Gauss. In other versions, the surface field can be not greater than about 3000 Gauss, such as not greater than about 2500 Gauss. Embodiments of the surface field of the leash magnet 21 can be in a range between any of these values.

Embodiments of the leash magnet 21 also may comprise a residual induction, or residual flux density (Brmax). For example, the Brmax can be at least about 12,000 Gauss, at least about 13,000 Gauss, or even at least about 14,000 Gauss. Other versions of the Brmax can be not greater than about 18,000 Gauss, such as not greater than about 17,000 Gauss, or even not greater than about 16,000 Gauss. Embodiments of the Brmax of the leash magnet 21 can be in a range between any of these values.

Other embodiments of the leash magnet 21 may include a maximum energy product (BHmax). For example, the BHmax can be at least about 45 MGOe, such as at least about 48 MGOe, at least about 51 MGOe. In other versions, the BHmax can be not greater than about 60 MGOe, such as not greater than about 57 MGOe, or even not greater than about 54 MGOe. Embodiments of the BHmax of the leash magnet 21 can be in a range between any of these values.

Versions of the leash magnet 21 may include one or more substantially flat magnets. For example, the leash magnet 21 may comprise a rectangular magnet or a square magnet. The leash magnet 21 may be magnetized through a thickness comprising a smallest dimension thereof. In one version, the leash magnet 21 may have a side dimension of in a range of about 0.5 inches to about 1 inch.

Embodiments of the leash magnet 21 may include a pull force. For example, the pull force can be at least about 10 pounds, such as at least about 20 pounds, or even at least about 30 pounds. In other versions, the pull force can be not greater than about 60 pounds, such as not greater than about 50 pounds, or even not greater than about 40 pounds. Embodiments of the pull force of the leash magnet 21 can be in a range between any of these values.

Embodiments of the accessory magnet 23 may comprise a spherical magnet or a disc magnet. For example, the accessory magnet 23 may have a diameter in a range of about 0.5 inches to about 0.75 inches. The accessory magnet 23 may be axially magnetized. In addition, the accessory magnet 23 may include a pull force. In some examples, the pull force can be at least about 5 pounds, such as at least about 8 pounds, or even at least about 10 pounds. In other examples, the pull force can be not greater than about 25 pounds, such as not greater than about 20 pounds, or even not greater than about 15 pounds. Embodiments of the pull force of the accessory magnet 23 can be in a range between any of these values.

Versions of the accessory magnet 23 may be embedded in the accessory 13, as shown in the drawings. In one example, the accessory magnet 23 can be located adjacent an outer surface of the accessory 13. In another example, the location of the accessory magnet 23 with respect to the accessory 13 may cause the accessory 13 to be eccentric and imbalanced, and move at least somewhat eccentrically. Embodiments of the accessory 13 may be provided with an opening 25 sealed with a cover 27. The accessory magnet 23 may be located in the opening 25 beneath the cover 27.

Embodiments of the accessory magnet 23 may be located approximately in a center of the accessory 13. For example, the accessory 13 can be hollow, such that the accessory magnet 23 may be located in the hollow of the accessory 13. In some versions, the accessory magnet 23 is not directly attached to the accessory 13, such that the accessory magnet 23 is free to move around inside the hollow of the accessory 13. In another version, the accessory 13 can be substantially solid and is not hollow. Alternatively, the opening in the accessory 13 can be sized to closely receive the accessory magnet 23 to limit its range of motion therein.

The accessory magnet 23 may comprise a surface field. For example, the surface field can be at least about 1500 Gauss, such as at least about 3000 Gauss, or even at least about 4500 Gauss. In other versions, the surface field can be not greater than about 9,000 Gauss, such as not greater than about 9,000 Gauss, or even not greater than about 9,000 Gauss. Embodiments of the surface field of the accessory magnet 23 can be in a range between any of these values.

Other embodiments of the accessory magnet 23 may include a Brmax. For example, the Brmax can be at least about 12,000 Gauss, such as at least about 12,250 Gauss, or even at least about 12,500 Gauss. In other versions, the Brmax can be not greater than about 14,000 Gauss, such as not greater than about 13,750 Gauss, or even not greater than about 13,500 Gauss. Embodiments of the Brmax of the accessory magnet 23 can be in a range between any of these values.

Still other embodiments of the accessory magnet 23 can include a BHmax. For example, the BHmax can be at least about 40 MGOe, such as at least about 41 MGOe, or even at least about 42 MGOe. In other versions, the BHmax can be not greater than about 45 MGOe, such as not greater than about 44 MGOe, or even not greater than about 43 MGOe.

In some embodiments, the magnets may comprise spherical magnets. For example, the spherical magnets can be on the order of about ⅝-inches in diameter, which may include a tolerance of about ±0.004-inches. Such magnets may be formed from a material such as NdFeB, Grade N42. Versions of the magnet may include a plating or a coating, such as nickel (e.g., NiCuNi). Embodiments of the magnet may comprise a magnetization direction, and may be axially magnetized with poles at two points, 180° opposite one another. The weight of such a magnet can be on the order of about 0.5 ounces. Magnets of this type may include a pull force of about 10 pounds to about 12 pounds. An example of such magnets may include a surface field of about 8815 Gauss, a Brmax of about 13,200 Gauss, and/or a BHmax of about 42 MGOe.

Other embodiments of the magnet may include a flat magnet. For example, the flat magnet can have dimensions on the order of about ¾×¾×⅛ inches, each of which may include a tolerance of about ±0.004 inches. Such magnets may be formed from a material such as NdFeB, Grade N52. The magnet may be plated or coated with a nickel coating, such as Ni—Cu—Ni. Versions of the magnet may have a magnetization direction through its thickness. The weight for such a magnet may be on the order of about 0.3 ounces. Magnets of this type may include a pull force on the order of about 13 pounds to about 55 pounds. An example of such magnets may include a surface field of about 2125 Gauss, a Brmax of about 14,800 Gauss, and/or a BHmax of about 52 MGOe.

In another embodiment, the magnet may comprise a disc magnet. For example, the disc magnet may have dimensions of about ⅝-inches in diameter, and a thickness on the order of about 3/32 inches, each of which may include a tolerance of about ±0.004 inches. Such a magnet may be formed from a material such as NdFeB, Grade N42. The magnet may be plated or coated with nickel, such as Ni—Cu—Ni. Versions of the magnet may include a magnetization direction with axial poles on the flat ends. In one example, the magnet can weigh about 0.125 ounces. The magnet can have a pull force of about 5 pounds to about 26 pounds. Versions of the magnet may include a surface field of about 1896 Gauss, a Brmax of about 13,200 Gauss, and/or a BHmax of about 42 MGOe.

Having strong magnets, as described herein, on both the leash and the accessories enables the accessories to be retained on the leash under almost any circumstances. Thus, despite the significant weight of the accessories, they will be retained by the leash even when the leash is secured to larger pets under walking, running and playing conditions. The accessories are designed to be removed from the leash only when desired. This can be done by applying direct force to both the leash and the chosen accessory to overcome their magnetic attraction and intentionally separate them from each other.

One feature this enables for the subject invention is for pets that may pull or tug on the leash when walking. The location of one or more accessories near the collar at the bottom of the leash allows the pet to hold the accessory in its mouth (rather than the leash) while walking, even though the accessory is still magnetically bonded to the leash. Such a feature can enhance and make the pet walking experience more enjoyable. The availability to the pet of one or more accessories at any time of its choosing positively distracts and refocuses the pet from biting the leash. If the pet decides it no longer wants to carry the accessory in its mouth, the pet releases the accessory (which is still magnetically bonded to the leash) and the owner does not have to pick it up and carry it.

Regarding terminology, a leash also may be referred to as a lead, a lead line or a tether. A leash may comprise a strap, a rope, etc., that may be attached to the neck or head of an animal, such as a pet, for restraint or control. On the animal, some leashes clip or tie to a collar, harness or halter that is directly secured to the animal, while other types of leashes may be placed directly on the animal.

Other versions may include one or more of the following embodiments:

Embodiment 1. Pet products, comprising:

a leash comprising a material, a handle on one end configured for manual engagement by a user, a releasable clasp opposite the handle and configured to be attached to a collar or a harness of a pet, and a leash magnet affixed to the material and located between the handle and the releasable clasp;

an accessory having an accessory magnet, such that the accessory is configured to be magnetically and repeatably coupled to and detached from the leash magnet on the leash; and

the accessory has a weight of at least about 3 ounces and not greater than about 8 ounces.

Embodiment 2. The pet products of any of these embodiments, wherein the material of the leash comprises at least one of woven polymer material, flat nylon, tubular nylon, flat leather, braided leather, cotton, chain, rope, polypropylene webbing and polyester webbing.

Embodiment 3. The pet products of any of these embodiments, wherein an only way to couple the accessory to the leash is via magnetism.

Embodiment 4. The pet products of any of these embodiments, wherein the accessory comprises at least one of a pet toy, ball, a nubble ball, a bone-shaped object, a pouch, waste bag dispenser, water holder, food container, grooming device, hook attachment for storage, light and a holder configured to hold or retain a separate device.

Embodiment 5. The pet products of any of these embodiments, wherein the separate device is at least one of a telephone, smartphone, key, disposable bags, liquid container, food container, grooming device, grooming wipes, wallet, identification or pet tags.

Embodiment 6. The pet products of any of these embodiments, wherein the leash magnet and the accessory magnet comprise neodymium magnets or ceramic magnets.

Embodiment 7. The pet products of any of these embodiments, wherein the leash magnet is embedded in the leash.

Embodiment 8. The pet products of any of these embodiments, wherein the leash magnet has sufficient magnetic strength to magnetically retain a plurality of accessories on the leash.

Embodiment 9. The pet products of any of these embodiments, wherein the accessory comprises a first accessory and a second accessory, the first accessory is configured to be magnetically retained by the leash magnet on a first side of the leash, and the second accessory is configured to be magnetically retained by the leash magnet on a second side of the leash.

Embodiment 10. The pet products of any of these embodiments, wherein the leash magnet is sewn in a pouch on the leash.

Embodiment 11. The pet products of any of these embodiments, wherein pouch comprises a pouch cover sewn to the leash, and the pouch cover has a thickness that is less than that of the leash.

Embodiment 12. The pet products of any of these embodiments, wherein the leash magnet comprises a plurality of leash magnets.

Embodiment 13. The pet products of any of these embodiments, wherein each of the leash magnets comprises a first polarity oriented toward the leash, and a second polarity oriented away from the leash, such that all of the leash magnets share a same orientation with respect to the leash.

Embodiment 14. The pet products of any of these embodiments, wherein the leash magnets are spaced apart from each other along the leash.

Embodiment 15. The pet products of any of these embodiments, wherein each of the leash magnets weigh at least about 0.25 ounces.

Embodiment 16. The pet products of any of these embodiments, wherein at least two of the leash magnets are located on opposite sides of the leash.

Embodiment 17. The pet products of any of these embodiments, wherein each of the leash magnets comprises a surface field in a range of about 1500 Gauss to about 3000 Gauss, a Brmax in a range of about 12,000 Gauss to about 18,000 Gauss, and a BHmax in a range of about 45 MGOe to about 60 MGOe.

Embodiment 18. The pet products of any of these embodiments, wherein the leash magnet and the accessory magnet are nickel plated.

Embodiment 19. The pet products of any of these embodiments, wherein the leash magnet comprises a substantially flat magnet.

Embodiment 20. The pet products of any of these embodiments, wherein the leash magnet comprises a rectangular magnet.

Embodiment 21. The pet products of any of these embodiments, wherein the leash magnet is magnetized through a thickness comprising a smallest dimension thereof, and the leash magnet has a pull force in a range of about 10 pounds to about 60 pounds.

Embodiment 22. The pet products of any of these embodiments, wherein the leash magnet comprises a side dimension of in a range of about 0.5 inches to about 1 inch.

Embodiment 23. The pet products of any of these embodiments, wherein the accessory magnet comprises a spherical magnet or a disc magnet, and the accessory magnet comprises a diameter in a range of about 0.5 inches to about 0.75 inches.

Embodiment 24. The pet products of any of these embodiments, wherein the accessory magnet is axially magnetized and has a pull force in a range of about 5 pounds to about 25 pounds.

Embodiment 25. The pet products of any of these embodiments, wherein the accessory magnet is embedded in the accessory.

Embodiment 26. The pet products of any of these embodiments, wherein the accessory magnet is located adjacent an outer surface of the accessory.

Embodiment 27. The pet products of any of these embodiments, wherein a location of the accessory magnet with respect to the accessory causes the accessory to be eccentric and imbalanced, and causes the accessory to move at least somewhat eccentrically.

Embodiment 28. The pet products of any of these embodiments, wherein the accessory has an opening sealed with a cover, and the accessory magnet is located in the accessory beneath the cover.

Embodiment 29. The pet products of any of these embodiments, wherein the accessory magnet is located approximately in a center of the accessory.

Embodiment 30. The pet products of any of these embodiments, wherein the accessory is hollow, and the accessory magnet is located in the hollow of the accessory.

Embodiment 31. The pet products of any of these embodiments, wherein the accessory magnet is not directly attached to the accessory, such that the accessory magnet is free to move around inside the hollow of the accessory.

Embodiment 32. The pet products of any of these embodiments, wherein the accessory is substantially solid and is not hollow.

Embodiment 33. The pet products of any of these embodiments, wherein the accessory magnet comprises a surface field in a range of about 1500 Gauss to about 9,000 Gauss, a Brmax in a range of about 12,000 Gauss to about 14,000 Gauss, and a BHmax in a range of about 40 MGOe to about 45 MGOe.

Embodiment 34. The pet products of any of these embodiments, wherein leash magnet comprises only two leash magnets that are spaced apart from each other on the leash.

Embodiment 35. The pet products of any of these embodiments, wherein the leash magnet comprises a first leash magnet located adjacent the handle, a second leash magnet located adjacent to the releasable clasp, and the second leash magnet is configured to remain magnetically bonded to the accessory when grasped in a mouth of the pet, and when the accessory is released from the mouth of the pet.

Embodiment 36. The pet products of any of these embodiments, wherein the first leash magnet is located closer to the handle than the second leash magnet is located relative to the releasable clasp.

Embodiment 37. A method of walking a pet, comprising:

(a) providing a leash with a leash magnet and an accessory with an accessory magnet, and attaching the leash to a pet;

(b) magnetically bonding the accessory to the leash with the leash magnet and the accessory magnet;

(c) walking the pet on the leash, and permitting the pet to place the accessory in its mouth, but not the leash, while the accessory remains magnetically bonded to the leash; and

(d) permitting the pet to release the accessory from its mouth, such that the accessory remains magnetically bonded to the leash, and a person walking the pet does not have to pick up the accessory and carry the accessory.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. Pet products, comprising:
a leash comprising a material, a handle on one end configured for manual engagement by a user, a releasable clasp opposite the handle and configured to be attached to a collar or a harness of a pet, and a leash magnet affixed to the material and located between the handle and the releasable clasp;
an accessory having an accessory magnet, such that the accessory is configured to be magnetically and repeatably coupled to and detached from the leash magnet on the leash; and
the accessory has a weight of at least about 3 ounces and not greater than about 8 ounces.

2. The pet products of claim 1, wherein the material of the leash comprises at least one of woven polymer material, flat nylon, tubular nylon, flat leather, braided leather, cotton, chain, rope, polypropylene webbing and polyester webbing.

3. The pet products of claim 1, wherein an only way to couple the accessory to the leash is via magnetism.

4. The pet products of claim 1, wherein the accessory comprises at least one of a pet toy, ball, nubble ball, bone-shaped object, pouch, waste bag dispenser, water holder, food container, grooming device, hook attachment for storage, light and a holder configured to hold or retain a separate device.

5. The pet products of claim 1, wherein the leash magnet and the accessory magnet comprise neodymium magnets or ceramic magnets.

6. The pet products of claim 1, wherein the leash magnet is embedded in the leash.

7. The pet products of claim 1, wherein the leash magnet has sufficient magnetic strength to magnetically retain a plurality of accessories on the leash.

8. The pet products of claim 1, wherein the leash magnet is sewn in a pouch on the leash.

9. The pet products of claim 1, wherein the leash magnet comprises a plurality of leash magnets.

10. The pet products of claim 1, wherein the leash magnet comprises a substantially flat magnet.

11. The pet products of claim 1, wherein the leash magnet comprises a rectangular magnet.

12. The pet products of claim 1, wherein the accessory magnet comprises a spherical magnet or a disc magnet, and the accessory magnet comprises a diameter in a range of about 0.5 inches to about 0.75 inches.

13. The pet products of claim 1, wherein the accessory magnet is embedded in the accessory.

14. The pet products of claim 1, wherein a location of the accessory magnet with respect to the accessory causes the accessory to be eccentric and imbalanced, and causes the accessory to move at least somewhat eccentrically.

15. The pet products of claim 1, wherein the accessory has an opening sealed with a cover, and the accessory magnet is located in the accessory beneath the cover.

16. The pet products of claim 1, wherein the accessory magnet is located approximately in a center of the accessory.

17. The pet products of claim 1, wherein the accessory is hollow, and the accessory magnet is located in the hollow of the accessory.

18. The pet products of claim 1, wherein the accessory is substantially solid and is not hollow.

19. The pet products of claim 1, wherein the accessory magnet comprises a surface field in a range of about 1500 Gauss to about 9,000 Gauss, a Brmax in a range of about 12,000 Gauss to about 14,000 Gauss, and a BHmax in a range of about 40 MGOe to about 45 MGOe.

20. The pet products of claim 1, wherein the leash magnet comprises a first leash magnet located adjacent the handle, a second leash magnet located adjacent to the releasable clasp, and the second leash magnet is configured to remain magnetically bonded to the accessory when grasped in a mouth of the pet, and when the accessory is released from the mouth of the pet.
